(19) United States
(12) Patent Application Publication
(10) Pub. No.: US 2024/0128600 A1
(43) Pub. Date: Apr. 18, 2024

(54) LAMINATION TYPE BATTERY

(71) Applicant: TOYOTA JIDOSHA KABUSHIKI KAISHA, Toyota-shi Aici-ken (JP)

(72) Inventor: SATOMI YAMAMOTO, Miyoshi-shi Aichi-ken (JP)

(73) Assignee: TOYOTA JIDOSHA KABUSHIKI KAISHA, Toyota-shi Aichi-ken (JP)

(21) Appl. No.: 18/390,001

(22) Filed: Dec. 20, 2023

Related U.S. Application Data
(63) Continuation of application No. 17/346,659, filed on Jun. 14, 2021.

(30) Foreign Application Priority Data
Jun. 19, 2020 (JP) 2020-105879

(51) Int. Cl. H01M 50/533; H01M 50/534

(52) U.S. Cl. CPC H01M 50/533; H01M 50/534

(57) ABSTRACT

A lamination type battery herein disclosed includes a plurality of electrode bodies and a connection terminal. The electrode bodies are formed in a plate shape, and are stacked one on another, with a thickness direction thereof being a lamination direction. The connection terminal electrically connects the first electrode body and second electrode body which are mutually and adjacently stacked. Each of the electrode bodies includes a pair of collector tabs extending outward along the plate surface. One collector tab of the first electrode body and one collector tab of the second electrode body are joined to the connection terminal from mutually opposite directions in the lamination direction.

### CROSS-REFERENCE TO RELATED APPLICATIONS

This application is a continuation application of U.S. patent application Ser. No. 17/346,659, filed on Jun. 14, 2021, entitled LAMINATION TYPE BATTERY, which claims priority to Japanese Patent Application No. 2020-105879 filed on Jun. 19, 2020, the entire contents of which are incorporated in the present specification by reference.

### BACKGROUND OF THE INVENTION

### 1. Field of the Invention

The present teaching relates to a lamination type battery including a plurality of electrode bodies stacked one on another therein.

### 2. Description of the Related Art

Batteries such as a lithium ion secondary battery have been widely used as portable power supply for a personal computer, a portable terminal, or the like, or as a power supply for driving vehicles such as an electric vehicle (EV), a hybrid vehicle (HV), and a plug-in hybrid vehicle (PHV). A battery has an electrode body as a power generating element. The electrode body may be provided with a pair of collector tabs (a positive electrode collector tab and a negative electrode collector tab). A terminal is joined with the collector tabs. For example, in the electrode body of the battery disclosed in Japanese Patent Application Publication No. 2020-24783, a pair of collector tabs extend in the same direction.

### SUMMARY

In a lamination type battery including a plurality of electrode bodies stacked one on another therein, a plurality of electrode bodies have to be electrically connected by joining respective collector tabs of the plurality of electrode bodies to a terminal together. With a conventional lamination type battery, application of an unnecessary force between the plurality of collector tabs and the terminal may result in deficiencies such as separation of joint, and breakage of the foil forming the electrode body. Further, it is difficult to reduce the volume of the joint part between the plurality of collector tabs and the terminal, which may result in the reduction of the energy density of the lamination type battery.

It is a typical object of the present teaching to provide a lamination type battery in which respective collector tabs of a plurality of electrode bodies and a terminal are properly joined.

In order to attain such an object, a lamination type battery of one aspect herein disclosed includes: a plurality of electrode bodies formed in a plate shape, and stacked one on another, with a thickness direction thereof being a lamination direction; and a connection terminal electrically connecting the first electrode body and second electrode body which are mutually and adjacently stacked. Each of the first electrode body and the second electrode body includes a pair of collector tabs extending outward along a plate surface, and one of the collector tabs of the first electrode body and one of the collector tabs of the second electrode body are joined to the connection terminal from mutually opposite directions in the lamination direction.

The two collector tabs extending from each of the stacked two electrode bodies are shifted in the lamination direction. Therefore, when the two collector tabs are joined with the connection terminal from the same direction in the lamination direction, the joining is required to be implemented such that one of the collector tabs is bent more largely than the other of the collector tabs. Accordingly, the joint part tends to be applied with an unnecessary force, and this also makes it difficult to reduce the volume of the joint part. In contrast, with the lamination type battery in accordance with the present disclosure, the connection terminal is situated between the two collector tabs. Therefore, when the connection terminal is seen from the direction crossing with both of the lamination direction of the plurality of electrode bodies, and the direction of extension of the collector tabs, the joint shape of each collector tab relative to the connection terminal tends to be a symmetric shape. Accordingly, the joint part is less likely to be applied with an unnecessary force, and this also makes it easy to reduce the volume of the joint part.

In accordance with an effective one aspect of the lamination type battery herein disclosed, the pair of collector tabs extend from the electrode body in mutually different directions. In this case, as compared with the case where the pair of collector tabs extend in the same direction, it is easier to set the width of each collector tab to be greater in order to reduce resistance. Further, it is also easy to ensure a space for operation of joining the collector tabs to the connection terminal.

In accordance with an effective one aspect of the lamination type battery herein disclosed, the electrode bodies have a rectangular plate shape, and each of the pair of collector tabs is provided at each of a pair of mutually opposing side surfaces among four side surfaces surrounding each of a pair of wide surfaces of the electrode bodies. In this case, as compared with the case where the shape of the electrode body is a circular shape, or the like, it is easier to implement alignment for stacking the plurality of electrode bodies. Further, the shape of the electrode body including a pair of collector tabs has a nearly rotationally symmetric shape. For this reason, it is also easy to handle the electrode body at the time of manufacturing.

In accordance with an effective one aspect of the lamination type battery herein disclosed, when a longitudinal direction of the side surface on which the collector tab is provided (i.e., the direction crossing with both of the lamination direction of the plurality of electrode bodies and the direction of extension of the collector tabs) is referred to as a width direction of the electrode body, positions of the pair of collector tabs in the width direction are different from each other. In this case, one of the identical two electrode bodies is inverted upside down for stacking. As a result, the positive electrode collector tab and the negative electrode collector tab are joined to the connection terminal at one side, and the positions of the positive electrode collector tab and the negative electrode collector tab in the width direction at the opposite side become different positions. Accordingly, the first electrode body and the second electrode body of the identical electrode bodies are properly connected in series with each other.

In accordance with an effective one aspect of the lamination type battery herein disclosed, a material of the connection terminal is the same as the material of at least one of the pair of collector tabs. In this case, at least one of the pair of the collector tabs is joined to the connection terminal with a higher strength.

In accordance with an effective one aspect of the lamination type battery herein disclosed, the connection terminal is a joined member in which a material of one of the pair of collector tabs and a material of the other of the pair of collector tabs are joined. In this case, each of the pair of collector tabs is joined to the connection terminal with a high strength. It should be noted that a specific aspect of the connection terminal, which is a joined member, can be appropriately selected. For example, a cladding material obtained by stretching metals of different materials in a pressurized state for joining may be used as the connection terminal. Alternatively, a joined member obtained by joining metals of different materials by ultrasonic joining, resistance welding, laser welding, fastening, or the like may be used as the connection terminal. In this case, joining of a plurality of metals may be performed in advance before joining the collector tabs to the connection terminal. Alternatively, joining of a plurality of metals may be performed after joining the collector tabs to respective metals.

### BRIEF DESCRIPTION OF THE DRAWINGS

FIG. 1 is a plan view of a lamination type battery 1 from which an exterior body 5 and a holder 40 have been omitted;

FIG. 2 is an exploded perspective view of a first electrode body 10A, a second electrode body 10B, an insulation member 7, and a connection terminal 30;

FIG. 3 is a view of the joint part between the collector tabs 11A and 12B and the connection terminal 30 as seen from the width direction (the lower part of FIG. 1); and

FIG. 4 is a view of the joint part between the collector tabs 11A and 12B and the connection terminal 30 as seen from the extension direction (the right side of FIG. 1).

### DETAILED DESCRIPTION OF THE PREFERRED EMBODIMENTS

Below, one of typical embodiments in the present disclosure will be described in detail by reference to the accompanying drawings. The matters other than matters particularly mentioned in this specification, and required for practicing the present invention can be grasped as design matters of those skilled in the art based on the related art in the present field. The present teaching can be executed based on the contents disclosed in the present specification, and the technical common sense in the present field. It should be noted that in the following accompanying drawings, the members/parts providing the same effect are given the same numerals and signs for description. Further, the dimensional relation (such as length, width, or thickness) in each drawing does not reflect the actual dimensional relation.

In the present specification, the term “battery” is a term denoting an electric storage device capable of extracting the electric energy in general, and a concept including a primary battery and a secondary battery. The term “secondary battery” denotes an electric storage device capable of repeatedly charging and discharging in general, and includes a capacitor such as an electric double layer capacitor (i.e., a physical battery) other than a so-called storage battery such as a lithium ion secondary battery, a nickel hydrogen battery, or a nickel cadmium battery (i.e., a chemical battery).

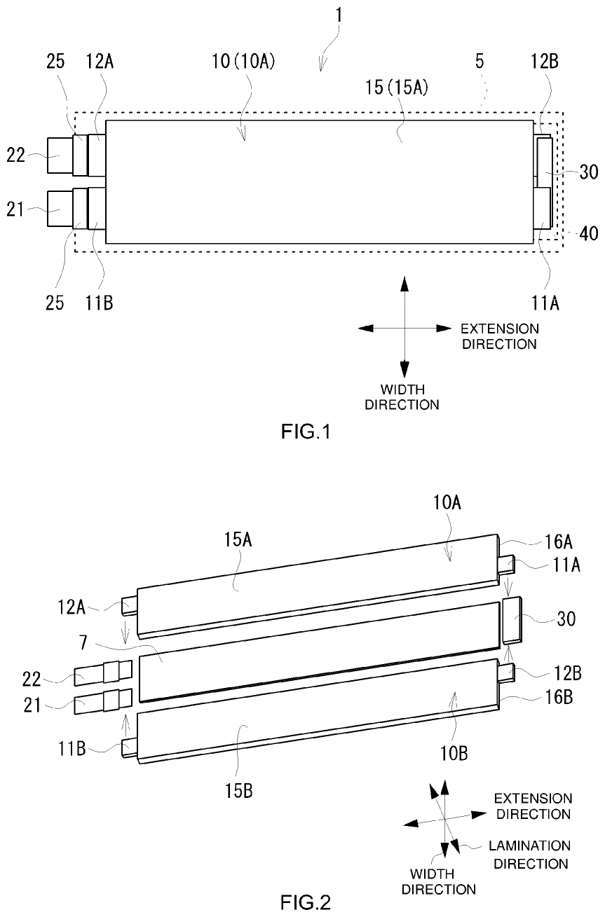

Referring to FIGS. 1 and 2, the configuration of the lamination type battery 1 of the present embodiment will be described. The depth direction on a paper plane in FIGS. 1 and 2 is referred to as the lamination direction of the electrode body 10 (i.e., the thickness direction of the electrode body 10). The vertical direction on a paper plane in FIG. 1 is referred to as the width direction of the lamination type battery 1 and the electrode body 10. The horizontal direction on a paper plane in FIG. 1 is referred to as the extension direction of the lamination type battery 1 and the electrode body 10.

The lamination type battery 1 of the present embodiment includes an exterior body 5, a plurality of electrode bodies 10 (a first electrode body 10A and a second electrode body 10B), external terminals 21 and 22 (a positive electrode external terminal 21 and a negative electrode external terminal 22), a connection terminal 30, and a holder 40. In FIG. 1, the exterior body 5 is indicated with a dotted line covering the periphery of the electrode bodies 10, and the like. Further, in FIG. 1, the holder 40 is indicated with a dotted line covering the joint part including the connection terminal 30.

The exterior body 5 accommodates the electrode bodies 10, and the like in the inside thereof. As one example, for the exterior body 5 of the present embodiment, a laminate film having appropriate flexibility is used. However, the material for the exterior body 5 can be changed. For example, an exterior body made of a metal having appropriate rigidity or made of a resin may be used.

The electrode body 10 is a power generating element in the lamination type battery 1. The lamination type battery 1 is desirably a secondary battery having a high energy density of various batteries. The lamination type battery 1 of the present embodiment is a lithium ion battery of one example of particularly desirable secondary batteries. However, the lamination type battery 1 may be a secondary battery (e.g., a nickel hydrogen battery) other than a lithium ion battery. Further, the lamination type battery 1 of the present embodiment is an all-solid-state battery whose electrolytic solution has been replaced with a solid electrolyte. However, the lamination type battery 1 is not required to be an all-solid-state battery, and the electrolytic solution may be accommodated in the inside of the exterior body 5.

In the electrode body 10 in the present embodiment, a positive electrode collector layer, a positive electrode active material layer, a solid electrolyte layer, a negative electrode active material layer, and a negative electrode collector layer are sequentially stacked one on another. As the positive electrode collector layer and the negative electrode collector layer, any collector layers can be used. For example, collector layers of various metals such as silver, copper, gold, aluminum, nickel, iron, stainless steel, or titanium can be used. The positive electrode active material layer includes a positive electrode active material, and optionally a conductivity aid, a binder, and solid electrolyte particles. As the positive electrode active materials, mention may be made of metal oxides containing lithium and at least one transition metal selected from manganese, cobalt, nickel, and titanium (e.g., lithium cobalt oxide, lithium nickel oxide, lithium nickel cobalt manganese oxide, and the like). For the solid electrolyte layer, materials usable as the solid electrolyte of the all-solid-state battery can be used. For example, sulfide type amorphous solid electrolyte particles such as 8Li₂O·67Li₂S·25P₂S₅, Li₂S, P₂S₅, Li₂S—SiS₂, LiI—Li₂S—SiS₂, LiI—Li₂S—P₂S₅, or LiI—Li₂S—B₂S₃, oxide type amorphous solid electrolyte particles such as Li₂O—B₂O₃—P₂O₅ or Li₂O—SiO₂, or crystalline oxide such as Li_{1.3}Al_{0.3}Ti_{0.7}(PO₄)₃ or Li_{1+x+y}AₓTi₂₋ₓSi_{y}P_{3-y}O₁₂ (A is Al or Ga, 0≤x≤0.4, 0<y≤0.6) can be used. The negative electrode active material layer includes a negative electrode active material, and optionally a conductivity aid, a binder, and solid electrolyte particles. The negative electrode active material has no particular restriction so long as it can occlude/discharge metal ions such as lithium ions.

As shown in FIG. 2, the outer shape of the electrode body 10 is formed in a plate shape. Particularly, the shape of the electrode body 10 in the present embodiment is a rectangular shape with the width direction being the lateral direction, and has a pair of wide surfaces 15, and four side surfaces 16A and 16B surrounding the periphery of the wide surfaces. In the lamination type battery 1, the plurality of electrode bodies 10 are stacked in the thickness direction. Particularly, the plurality of electrode bodies 10 are stacked one on another with the wide surfaces 15 of the mutually adjacent two electrode bodies 10 matching each other. As one example, with the lamination type battery 1 of the present embodiment, two electrode bodies 10 (the first electrode body 10A and the second electrode body 10B) are stacked. However, the number of the electrode bodies 10 may be 3 or more. Further, in the present embodiment, the identical electrode bodies 10 are stacked one on another, and are mounted in the lamination type battery 1. Therefore, as compared with the case where different electrode bodies are manufactured separately, and are stacked one on another, the manufacturing steps of the lamination type battery 1 are simplified.

It should be noted that in the present embodiment, an insulation member 7 (see FIG. 2) for preventing a short circuit is arranged between the mutually adjacent two electrode bodies 10 (in the present embodiment, between the first electrode body 10A and the second electrode body 10B). However, in the case where an insulation layer is previously provided on the surface of the electrode body 10, or in similar cases, the insulation member 7 can be omitted.

As shown in FIG. 2, each of the plurality of electrode bodies 10 has a pair of (two) collector tabs. The pair of collector tabs extend outward along the plate surface of the electrode body 10. Particularly, the first electrode body 10A has a positive electrode collector tab 11A and a negative electrode collector tab 12A. The second electrode body 10B has a positive electrode collector tab 11B and a negative electrode collector tab 12B.

The pair of collector tabs in the present embodiment extend from the electrode body 10 in mutually different directions. If the pair of collector tabs extend from the electrode body 10 in the same direction (e.g., in parallel with each other), the pair of collector tabs are required to be both set at the same edge (the same side surface 16) of the electrode body 10 in a plate shape. In this case, in order to prevent the electric connection between the two collector tabs provided at the same electrode body 10, respective widths of the collector tabs are required to be restricted. In contrast, the pair of collector tabs are allowed to extend from the electrode body 10 in mutually different directions. This facilitates the increase in width of respective collector tabs for reduction of the resistance. Further, respective positions of the collector tabs are apart from each other. For this reason, it is also easy to ensure the space for performing the joining operation described later, or the like.

More particularly, each of the pair of collector tabs is provided at each pair of mutually opposing side surfaces among each of the four side surfaces surrounding each of a pair of wide surfaces 15A and 15B of the electrode body 10 (each of the four side surfaces 16A of the first electrode body 10A, and the four side surfaces 16B of the second electrode body 10B). In other words, the pair of collector tabs extend in the directions exactly opposite to each other. Therefore, the shape of the electrode body 10 including the pair of collector tabs becomes a nearly rotationally symmetric shape. Accordingly, it is also easy to handle the electrode body 10 for manufacturing the lamination type battery 1.

Further, the longitudinal direction of the side surface on which the collector tab is provided (i.e., the direction crossing with both the lamination direction of the plurality of electrode bodies and the extension direction in which the collector tab extends) is referred to as the width direction. In this case, the positions in the width direction of the pair of collector tabs are different from each other. For example, in the state shown in FIG. 2, the positive electrode collector tab 11A of the first electrode body 10A is situated on the lower side of the paper plane from the center in the width direction of the side surface of the first electrode body 10A. In contrast, the negative electrode collector tab 12A is situated on the upper side of the paper plane from the center in the width direction of the first electrode body 10A. As a result, the first electrode body 10A and the second electrode body 10B are properly connected in series, which will be described in detail later.

The connection terminal 30 electrically connects the mutually adjacently stacked first electrode body 10A and second electrode body 10B. As one example, in the lamination type battery 1 of the present embodiment, the first electrode body 10A and the second electrode body 10B are connected in series. Particularly, in the present embodiment, the positive electrode collector tab 11A of the first electrode body 10A and the negative electrode collector tab 12B of the second electrode body 10B are electrically connected with each other by the connection terminal 30, so that the first electrode body 10A and the second electrode body 10B are connected in series. However, the joint structure between the connection terminal 30 and the collector tab (which will be described in detail later) exemplified in the present embodiment may be used for connecting the first electrode body 10A and the second electrode body 10B in parallel with each other. In other words, the technology exemplified in the present embodiment is also applicable to the case where two positive electrode collector tabs 11A and 11B are connected to the connection terminal, and the case where the two negative electrode collector tabs 12A and 12B are connected to the connection terminal.

The external terminals 21 and 22 electrically connect the lamination type battery 1 to the outside. As one example, in the present embodiment, of the first electrode body 10A and the second electrode body 10B connected in series, the positive electrode external terminal 21 is joined to the positive electrode collector tab 11B of the second electrode body 10B, and the negative electrode external terminal 22 is joined to the negative electrode collector tab 12A of the first electrode body 10A. It should be noted that as shown in FIG. 1, the exterior body 5 accommodates the electrode bodies 10, and the like with the external terminals 21 and 22 protruding outward. Further, in the present embodiment, the electrode bodies 10, and the like are sealed hermetically in the inside of the exterior body 5 with a tab seal 25 for hermetically sealing the gap provided between the external terminals 21 and 22 and the exterior body 5.

The holder 40 (see FIG. 1) covers the pair of collector tabs 11A and 12B and the connection terminal 30 joined to one another, thereby guaranteeing the insulation property. The holder 40 may be formed of, for example, a material having the insulation property and proper rigidity (e.g., a resin).

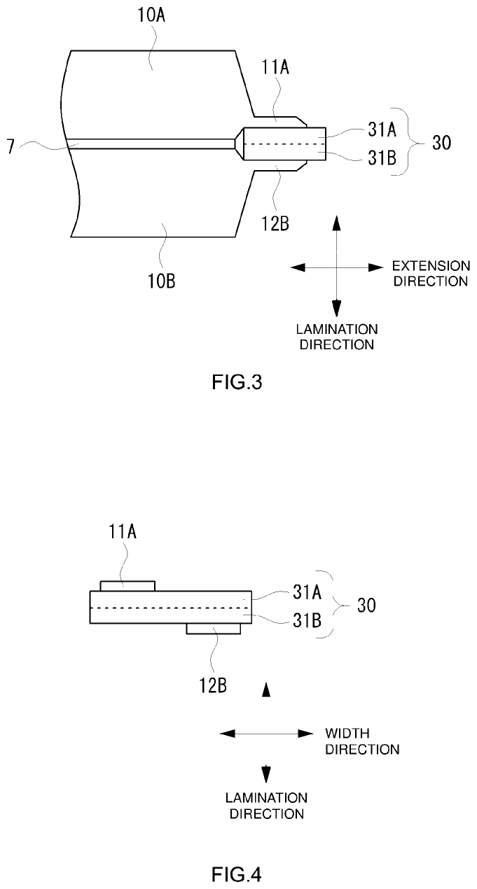

Below, the joint structure between the connection terminal 30 and the collector tabs 11A and 12B in the present embodiment will be described in detail. It should be noted that FIG. 3 is a view of the joint part between the collector tabs 11A and 12B and the connection terminal 30 as seen from the width direction (the lower part in FIG. 1). FIG. 4 is a view of the joint part between the collector tabs 11A and 12B and the connection terminal 30 as seen from the extension direction (the right side in FIG. 1).

As shown in FIGS. 3 and 4, in the lamination type battery 1 of the present embodiment, one collector tab (the positive electrode collector tab 11A in the present embodiment) of the first electrode body 10A, and one collector tab (the negative electrode collector tab 12B in the present embodiment) of the second electrode body 10B are joined to the connection terminal 30 from mutually opposite directions in the lamination direction. In other words, in the example shown in FIGS. 3 and 4, the positive electrode collector tab 11A is joined to the connection terminal 30 from the top part of the drawing. In contrast, the negative electrode collector tab 12B is joined to the connection terminal 30 from the lower part of the drawing. It should be noted that for the joining method of the collector tabs 11A and 12B and the connection terminal 30, for example, at least any one of ultrasonic joining, resistance welding, laser welding, and the like can be adopted.

As shown in FIG. 3, the two collector tabs 11A and 12B extending from the two stacked electrode bodies 10A and 10B, respectively, are shifted in the lamination direction. Therefore, when the two collector tabs 11A and 12B are joined to the connection terminal 30 from the same direction in the lamination direction, joining is required to be achieved with one collector tab bent more largely than the other collector tab. In this case, the joint part tends to be applied with an unnecessary force, and it is also difficult to reduce the volume of the joint part. In contrast, in the lamination type battery 1 of the present embodiment, the connection terminal 30 is situated between the two collector tabs 11A and 12B. Therefore, as shown in FIG. 3, when the connection terminal 30 is seen from the width direction, the joint shape of respective collector tabs 11A and 12B to the connection terminal 30 tends to be a symmetric (vertically symmetric in FIG. 3) shape. Accordingly, the joint part is less likely to be applied with an unnecessary force, and it is also easy to reduce the volume of the joint part. Further, in the present embodiment, the structure of the holder 40 (see FIG. 1) to be mounted to the joint part is also simplified.

In the present embodiment, the material for the positive electrode collector tabs 11A and 11B and the material for the negative electrode collector tabs 12A and 12B are different. Herein, when the material for the collector tab and the material for the connection terminal are different, the joint strength may be reduced. However, the connection terminal 30 in the present embodiment is a joined member obtained by joining one material with the other material for the two collector tabs 11A and 12B. Particularly, the connection terminal 30 in the present embodiment is a cladding material obtained by stretching a metal 31A of the same material as that for the positive electrode collector tabs 11A and 11B, and a metal 31B of the same material as that for the negative electrode collector tabs 12A and 12B in a pressurized state for joining therebetween. Therefore, the positive electrode collector tab 11A is joined to the metal 31A, and the negative electrode collector tab 12B is joined to the metal 31B. As a result, the two collector tabs 11A and 12B are both joined to the connection terminal 30 with a high strength.

As shown in FIG. 2, in the electrode body 10 (each of the first electrode body 10A and the second electrode body 10B) of the present embodiment, the positions in the width direction of the pair of collector tabs are different from each other. Therefore, one of the identical two electrode bodies 10 is inverted upside down for stacking. As a result, at one side (the right side of FIG. 2), the positive electrode collector tab 11A and the negative electrode collector tab 12B are joined to the connection terminal 30, and the positions in the width direction of the positive electrode collector tab 11B and the negative electrode collector tab 12A on the opposite side (the left side of FIG. 2) become different positions. Accordingly, the first electrode body 10A and the second electrode body 10B which are the identical electrode bodies 10 are properly connected in series.

The technology disclosed in the embodiment is just one example. Therefore, the technology exemplified in the embodiment can be changed. For example, the lamination type battery 1 of the embodiment incudes two electrode bodies 10 stacked one on another therein. However, the technology exemplified in the present disclosure is applicable even to a lamination type battery including three or more electrode bodies stacked one on another therein. In this case, it is essential only that the technology exemplified in the present disclosure is adopted for electrically connecting at least any group of the electrode bodies of the two or more groups of electrode bodies adjacent to one another.

The connection terminal 30 in the embodiment is a joined member in which one material of the two collector tabs 11A and 12B and the other material of the two collector tabs 11A and 12B are joined. However, the configuration of the connection terminal can be changed. For example, the material for the connection terminal may be the same as one material for the positive electrode collector tabs 11A and 11B and the negative electrode collector tabs 12A and 12B. In this case, one of the positive electrode collector tabs 11A and 11B and the negative electrode collector tabs 12A and 12B is joined to the connection terminal with a high strength, and the configuration of the connection terminal is simplified. Further, when the material for the positive electrode collector tabs 11A and 11B and the material for the negative electrode collector tabs 12A and 12B are the same, the material for the connection terminal may be the same as the material for the positive electrode collector tabs 11A and 11B and the negative electrode collector tabs 12A and 12B. In this case, the two collector tabs are both joined to the connection terminal with a high strength.

Up to this point, the specific examples of the present disclosure have been described in detail, but these are merely examples, and should not be construed as limiting the scope of the appended claims. The technology described in the appended claims includes those obtained by variously modifying or changing the specific examples exemplified up to this point. The lamination type battery herein disclosed is desirable for uses to be mounted on vehicles such as an electric vehicle (EV), a hybrid vehicle (HV), or a plug-in hybrid vehicle (PHV) required to have particularly high battery performances as a motor driving power supply.

What is claimed is:

1. A method for producing a lamination type battery comprising the steps of:
stacking a plurality of electrode bodies including a first electrode body and a second electrode body, and formed in a rectangular plate shape, one on another, with a thickness direction thereof being a lamination direction, wherein
the first electrode body and the second electrode body are mutually and adjacently stacked,
each of the first electrode body and the second electrode body includes a pair of collector tabs extending outward along a plate surface,
the pair of collector tabs extend from the electrode body in mutually different directions,
each of the pair of collector tabs is provided at each of a pair of mutually opposing side surfaces among four side surfaces surrounding each of a pair of wide surfaces of the electrode bodies, and
when a longitudinal direction of the side surface on which the collector tab is provided is referred to as a width direction of the electrode body, positions of the pair of collector tabs in the width direction are different from each other;
electrically connecting the first electrode body and the second electrode body by joining one of the collector tabs of the first electrode body and one of the collector tabs of the second electrode body to a connection terminal from mutually opposite directions in the lamination direction; and
accommodating the plurality of electrode bodies in an exterior body made of a laminate film.

2. The method according to claim 1, wherein a material of the connection terminal is the same as a material of at least one of the pair of collector tabs.

3. The method according to claim 1, wherein the connection terminal is a joined member in which a material of one of the pair of collector tabs with a material of the other of the pair of collector tabs are joined.
